(19) United States
(12) Patent Application Publication
(10) Pub. No.: US 2024/0308838 A1
(43) Pub. Date: Sep. 19, 2024

(54) CARTRIDGE SYSTEM COMPRISING A CARTRIDGE CLOSED BY A VALVE

(71) Applicant: FREEZIO AG, Amriswil (CH)

(72) Inventors: Marc Krüger, Bergisch Gladbach (DE); Günter Empl, Bergisch Gladbach (DE)

(21) Appl. No.: 18/564,671

(22) PCT Filed: Jul. 15, 2022
(86) PCT No.: PCT/EP2022/069893

§ 371 Date: Nov. 28, 2023

(30) Foreign Application Priority Data
Jul. 15, 2021 (DE) 10 2021 207 559.2

(51) Int. Cl. B67D 3/00; B67D 1/00; B67D 1/08

(52) U.S. Cl. CPC B67D 3/0032; B67D 1/0021; B67D 1/0078; B67D 1/0801; B67D 2001/0812; B67D 2001/0814

(57) ABSTRACT

The invention relates to a cartridge system for making a beverage, the cartridge system being insertable into a beverage preparation machine and comprising: a cartridge that includes a reservoir filled with a beverage substance; and a cartridge receptacle, the cartridge receptacle including a mixing chamber that can be brought in fluidic connection to the reservoir and a fluid feed line extending into the mixing chamber, wherein the cartridge system has a sealing element, characterized in that the cartridge can be reclosed with the aid of the sealing element.

### PRIOR ART

The present invention relates to a cartridge system for making a beverage, wherein the cartridge system is insertable into a beverage preparation machine, wherein the cartridge system has a cartridge, which comprises a reservoir filled with a beverage substance, and has a cartridge receptacle, wherein the cartridge receptacle has a mixing chamber, which can be fluidically connected to the reservoir, and a fluid feed, which opens into the mixing chamber, wherein the cartridge system comprises a sealing element.

Such systems are known from the prior art, for example from documents WO 2017/121 802 A1, WO 2017/121 801 A1, WO 2017/121 801 A1, WO 2017/121 799 A1, WO 2017/121 798 A1, WO 2017/121 797 A1, WO 2017/121 796 A1 and WO 2019/002 293 A1, and are used for making beverages from pre-portioned cartridges. Making beverages using such systems is highly convenient for the user, because the user merely needs to insert a cartridge and press a start button. The beverage preparation machine then makes the beverage fully automatically, which means in particular that the beverage substance is mixed with a predetermined quantity of liquid, in particular cold and carbonated water, and conducted into a drinking vessel. Beverages in particular can thus be made in a manner which is much easier, quicker and less laborious for the user. Here, the user may select from a multiplicity of different cartridges, such that the user can make different beverages according to their preference. It is important here for the beverage substance to be safely and stably stored in the cartridge, in particular also prior to the use of the cartridge system in the beverage preparation machine, in order to maintain the freshness and quality of the beverage substance. The cartridge system should also allow a reliable and reproducible beverage-making process.

At the same time, it is desirable to keep the outlay on materials as low as possible, and to achieve high flexibility in the use of such cartridge systems.

### DISCLOSURE OF THE INVENTION

It is therefore an object of the present invention to provide a cartridge system for making a beverage, which cartridge system can be inserted into a beverage preparation machine, and with which cartridge system the consumption of materials can be kept low and/or the possible applications and the flexibility in the use of cartridge systems can be increased.

Said object is achieved by means of a cartridge system according to claim 1. According to the invention, it is advantageously possible for the cartridge, or the reservoir of the cartridge, to be reclosable by means of the sealing element, in particular after a beverage has been made. The cartridge system can thus advantageously be used to prepare more than just one beverage. The consumption of materials can thus be reduced overall, because it is not necessary for a new cartridge and/or a new cartridge system to be used for each individual beverage. The consumption of cartridges and cartridge systems is thus reduced overall, whereby costs can be reduced. It is preferably the case that, when a beverage is prepared using the cartridge system according to the invention, not all of the beverage substance that is present in the reservoir of the cartridge in the initial state of the cartridge system is consumed, such that, after the beverage has been prepared, there is still sufficient beverage substance in the cartridge to prepare one or more further beverages, particularly preferably without the need to refill the cartridge with new beverage substance in the interim.

The sealing element is preferably provided for sealing off the reservoir or a main body of the cartridge in the initial state of the cartridge system. The sealing element preferably ensures that, before the preparation of the beverage is commenced (in the initial state of the cartridge system), the beverage substance remains within the reservoir and is hermetically sealed off there in order to ensure a long storage life and a consistent aroma. It is preferably also possible for relatively high internal pressures to be enclosed in the cartridge by means of the sealing element. The beverage substance, which is in particular in liquid form, can this be enclosed in the reservoir at an elevated pressure prior to the use of the cartridge system. It is thus possible for beverage substances with a relatively high carbonic acid content to be stored in the reservoir, in particular prior to the use of the cartridge system, without the risk of the seal of the reservoir, that is to say in particular the sealing element, developing leaks owing to the carbonic acid, and gas and/or liquid escaping, for example in the event of vibrations during the transport or during the storage of the cartridge system. In many cases, the relatively high carbonic acid content in turn has a positive effect both on the taste of the beverage that is to be made and on the expiration date of the cartridge. In order to maintain their freshness and quality, some beverage substances require particularly high internal pressures in the reservoir of the cartridge, which are provided for example by precarbonation. It is furthermore advantageously possible that the reservoir can be emptied using a relatively high pressure during the beverage-making process without undesired leaks occurring, for example in the region in which the sealing element is fastened to the cartridge. In this way, the drawing time can be shortened without the risk of impairment of the taste of the beverage that is to be made.

The cartridge preferably has glass. The cartridge preferably has a main body manufactured from glass. It is preferably conceivable that the entire cartridge is manufactured from glass, and is particularly preferably formed as a glass cartridge and/or glass bottle.

It is additionally or alternatively conceivable that the cartridge is manufactured entirely or partially from plastics material.

It is additionally or alternatively conceivable that the cartridge has a main body which is manufactured from aluminum and which, in its typical wall region, preferably has a wall thickness of between 0.01 and 0.5 millimeters, preferably between 0.01 and 0.2 millimeters, particularly preferably between 0.03 and 0.1 millimeters, and very particularly preferably of substantially 0.05 millimeters, in particular with an error tolerance of at most 15%. A main body manufactured from aluminum can be produced for example by deep drawing or extrusion.

The cartridge is preferably designed to withstand an internal pressure of up to 12 bar, preferably up to 10 bar, particularly preferably up to 8 bar, and very particularly preferably up to 6 bar, without rupturing (at a temperature of 20° C. and an ambient pressure of 1 bar). Here, the reservoir preferably has a volume of between 10 and 500 milliliters, particularly preferably between 30 and 200 milliliters. Larger or smaller volumes are however also conceivable. In particular, the cartridge system has a liquid beverage substance, which preferably contains carbonic acid. It is alternatively conceivable that the liquid beverage substance does not contain carbonic acid. The liquid beverage substance particularly preferably comprises a beverage concentrate, in particular a syrup.

The cartridge receptacle is preferably connected to the cartridge. The cartridge and the cartridge receptacle may in this case be connected directly (or immediately) or indirectly (for example via one or more intermediate elements).

According to the invention, it is conceivable for the cartridge receptacle to be understood as a mixing cap of the cartridge system.

Advantageous developments and refinements of the invention can be found in the subclaims and in the description that refers to the drawings.

In one preferred embodiment of the invention, provision is made whereby the cartridge is closed in an initial state of the cartridge system, wherein the cartridge is open, in particular such that a fluidic connection between the reservoir and the mixing chamber is formed, in a preparation state of the cartridge system, wherein the cartridge is closed in a reclosure state of the cartridge system, in particular after the preparation state. There is particularly preferably a liquid connection between the reservoir and the mixing chamber in the preparation state of the cartridge system. The cartridge is preferably sealed off by means of the sealing element in the reclosure state. It is conceivable here that the leak-tightness of the cartridge in the reclosure state corresponds, or is at least similar, to the leak-tightness in the initial state. It is however alternatively also possible that the leak-tightness of the cartridge in the reclosure state is reduced in relation to the leak-tightness of the cartridge in the initial state. It is for example conceivable that, in the reclosure state, the cartridge is not entirely hermetically sealed off, but in particular one or more gases can ingress into the cartridge and/or escape from the cartridge. It is conceivable here that, in the reclosure state, the cartridge is closed such that liquids and in particular also the beverage substance cannot emerge from the cartridge (and/or ingress into the cartridge). It is however alternatively also possible that, in the reclosure state, the cartridge is closed such that liquids and in particular the beverage substance can emerge from the cartridge preferably slowly, for example in droplet form. For example, it is conceivable that, in the reclosure state, the beverage substance remaining in the reservoir of the cartridge can emerge from the cartridge relatively slowly, in particular significantly more slowly than in the preparation state of the cartridge system. In particular, it is conceivable that only at most 20%, preferably at most 10%, particularly preferably at most 5%, further particularly preferably at most 1%, of the beverage substance present in the reservoir at the beginning of the reclosure state escapes or can escape from the cartridge over the duration of the reclosure state, in particular over a duration of up to 60 minutes, preferably up to 10 minutes, particularly preferably up to 1 minute. The beverage substance that thus emerges from the reservoir during the reclosure state preferably collects in the mixing chamber of the cartridge receptacle and is therefore preferably not lost for the preparation of a further beverage after the reclosure state.

In one preferred embodiment of the present invention, provision is made whereby the cartridge is open, in particular such that a fluidic connection between the reservoir and the mixing chamber is formed, in a further preparation state of the cartridge system, in particular after the reclosure state. The preparation state and the further preparation state are preferably mutually separate preparation states, between which the cartridge system is in the reclosure state. It is thus conceivable that one beverage is prepared in the preparation state and a further beverage is prepared in the further preparation state. At least two beverages can thus be prepared using a single cartridge or using the beverage substance in a single cartridge. There is particularly preferably a liquid connection between the reservoir and the mixing chamber in the further preparation state of the cartridge system.

In one preferred embodiment of the present invention, provision is made whereby the beverage substance that is present in the reservoir in the initial state of the cartridge system comprises at least one first portion and one second portion,
wherein the first portion of the beverage substances passes from the reservoir into the mixing chamber in the preparation state of the cartridge system,
wherein the second portion of the beverage substance passes from the reservoir into the mixing chamber in the further preparation state of the cartridge system. It is conceivable that the beverage substance that is present in the reservoir in the initial state furthermore comprises a third portion and optionally further portions. It is conceivable that the third portion passes from the reservoir into the mixing chamber in a yet further preparation state of the cartridge system, such that a third beverage is prepared. Correspondingly, yet further beverages can be prepared with yet further portions of the beverage substance.

In one preferred embodiment of the present invention, provision is made whereby the cartridge, in particular a main body of the cartridge, is closed at its side situated opposite a cartridge base by the sealing element in the initial state of the cartridge system, wherein the cartridge, in particular the main body of the cartridge, is closed at its side situated opposite the cartridge base by the sealing element in the reclosure state of the cartridge system. It is preferably conceivable that an opening of the cartridge is closed by means of the sealing element in the initial state of the cartridge system, with the opening being closed by means of the sealing element in the reclosure state of the cartridge system. It is preferably conceivable that the opening of the cartridge is circular. It is preferably possible for the opening to have a diameter of between 10 and 50 mm, particularly preferably between 15 and 30 mm, further particularly preferably of at least 18 mm (in particular with an error tolerance of at most 15%).

In one preferred embodiment of the present invention, provision is made whereby the sealing element is fastened to an edge of a cartridge wall of the cartridge.

In one preferred embodiment of the present invention, provision is made whereby the sealing element is crimped, adhesively bonded, sealed and/or welded to a cartridge wall of the cartridge. In particular, the sealing element is crimped, adhesively bonded, sealed and/or welded by way of a peripheral fastening region of the sealing element to the cartridge.

In one preferred embodiment of the present invention, provision is made whereby the cartridge comprises an in particular cup-shaped main body, wherein the main body is formed by means of the cartridge wall, which is closed on one side by a cartridge base, wherein the main body in particular surrounds the reservoir. The cartridge wall and the cartridge base are in particular formed as a single piece. It is preferably conceivable that the cartridge wall is cylindrical at least in a predominant region of the cartridge wall. The cartridge wall and the cartridge base may preferably be formed by a glass bottle. It is alternatively conceivable that the cartridge wall and the cartridge base are formed by a plastics material or a metal.

In one preferred embodiment of the present invention, provision is made whereby the sealing element comprises a reclosable region and/or a reclosable closure means. It is conceivable that the reclosable region and/or the reclosable closure means are designed such that a passage opening of the sealing element can be opened and closed again using the reclosable region and/or the reclosable closure means. It is particularly preferably possible for the fluidic connection between the reservoir of the cartridge and the mixing chamber of the cartridge receptacle to be formed by means of the reclosable region and/or the reclosable closure means of the sealing element in the preparation state and/or in the further preparation state of the cartridge system.

In one preferred embodiment of the present invention, provision is made whereby the reclosable closure means comprises a valve. It is preferably conceivable that the valve has plastics material, silicone, rubber and/or further materials. The valve is preferably designed as a metering valve. It is particularly preferably possible for the valve to be open in the preparation state and/or in the further preparation state of the cartridge system, such that a fluidic connection between the reservoir of the cartridge and the mixing chamber of the cartridge receptacle is formed via the valve in the preparation state and/or in the further preparation state of the cartridge system. The valve is preferably closed in the initial state and/or in the reclosure state of the cartridge system. It is conceivable that the valve is manufactured from the same material as the rest of the sealing element.

In one embodiment of the present invention, it is conceivable that the reclosable region and/or the reclosable closure means comprises a self-closing diaphragm. In particular, it is conceivable that the valve is formed by means of a self-closing diaphragm.

In one preferred embodiment of the present invention, provision is made whereby the reclosable closure means, in particular the valve, is designed such that the reclosable closure means opens and/or closes according to a pressure in the reservoir, in particular such that the reclosable closure means is open above a threshold value of a pressure in the reservoir and is closed below the threshold value of the pressure in the reservoir. The pressure within the reservoir is increased during the preparation of a beverage, that is to say in particular in the preparation state and in the further preparation state, whereby the reclosable closure means is preferably open in the preparation state and in the further preparation state. The reclosable closure means is in this case particularly preferably designed as a reclosable diaphragm and/or as a reclosable valve.

In particular, in one preferred embodiment of the present invention, provision is made whereby the valve is designed such that the valve opens and/or closes according to a pressure in the reservoir, in particular such that the valve is open above a threshold value of a pressure in the reservoir and is closed below the threshold value of the pressure in the reservoir. The pressure within the reservoir is increased during the preparation of a beverage, that is to say in particular in the preparation state and in the further preparation state, whereby the valve is preferably open in the preparation state and in the further preparation state. Here, the valve is designed in particular as a metering valve.

In one embodiment of the present invention, it is conceivable that the reclosable region and/or the reclosable closure means comprises a flap and/or a stopper, wherein the flap and/or the stopper are in particular acted on with a restoring force. It is particularly preferably conceivable that the flap and/or the stopper can be transferred from an opened position into a closed position by means of the restoring force, in particular such that the cartridge can be transferred into the reclosure state by means of the flap and/or the stopper after the preparation state.

In one preferred embodiment of the present invention, provision is made whereby
the reclosable region and/or the reclosable closure means is closed in the initial state of the cartridge system,
the reclosable region and/or the reclosable closure means is open, in particular such that the fluidic connection between the reservoir and the mixing chamber is formed by means of the reclosable region and/or the reclosable closure means, in the preparation state of the cartridge system,
the reclosable region and/or the reclosable closure means is closed in the reclosure state of the cartridge system.

In one preferred embodiment of the present invention, provision is made whereby the sealing element has an in particular rigid or semirigid sealing body. It is preferably conceivable that the sealing element is fastened in the region of its sealing body to the cartridge wall.

In one preferred embodiment of the present invention, provision is made whereby the reclosable region and/or the reclosable closure means is connected to the sealing body. It is conceivable that the reclosable region and/or the reclosable closure means are formed as a single piece with the sealing body, or that the reclosable region and/or the reclosable closure means are elements which are separate from the sealing body and connected to the sealing body. It is conceivable that the sealing body and the reclosable region and/or the reclosable closure means have the same or different materials. It is conceivable that the sealing body has a passage opening that can be opened and closed again using the reclosable region and/or the reclosable closure means.

In one preferred embodiment of the present invention, provision is made whereby the cartridge system has a movable spike, wherein the spike is movable between a retracted position, in which the spike is spaced from the sealing element, and a deployed position, in which the spike extends through the sealing element and projects into the reservoir. It is conceivable for the spike to be designed as a piercing spike.

In one preferred embodiment of the present invention, provision is made whereby the spike, when in its deployed position, extends through the sealing element in the reclosable region of the sealing element.

In one preferred embodiment of the present invention, provision is made whereby the spike is situated in its retracted position in the initial state of the cartridge system, wherein the spike is situated in its deployed position in the preparation state of the cartridge system.

In one preferred embodiment of the present invention, provision is made whereby the spike is situated in its retracted position in the reclosure state of the cartridge system. It is thus possible in particular for the spike to be moved out of the reclosable region and/or out of the reclosable closure means of the sealing element, with the result that the reclosable region and/or the reclosable closure element advantageously close, after the preparation state of the cartridge system. It is for example conceivable that the reclosable region of the sealing element has a flap and/or is a region of the sealing element that is acted on with a restoring force, for example a region of the sealing element that is acted on with a restoring force by a spring. It is conceivable that the spike, when in its deployed position, opens and extends through said reclosable region. If the spike is transferred from the deployed position into its retracted position, the reclosable region of the sealing element closes, in particular owing to the restoring force acting on the reclosable region. It is for example conceivable here that a flap of the reclosable region, which flap is acted on by the restoring force, closes. In particular, the reclosure state of the cartridge system is thus attained. If the spike moves from its retracted position into its deployed position again, the reclosable region is then preferably opened again, in particular by the spike. The further preparation state of the cartridge system can thus be attained.

In one preferred embodiment of the present invention, provision is made whereby the spike is situated in its deployed position in the reclosure state of the cartridge system. It is thus particularly advantageously possible that, in the reclosure state of the cartridge system, too, the spike remains in its deployed position in which it has been led through the sealing element. In this case, the sealing element preferably comprises a reclosable closure means. The reclosable closure means is preferably configured to be spaced from the spike—when the spike is in the deployed position. Alternatively, the reclosable closure means may also be arranged so as to adjoin to the spike—when the spike is in the deployed position. The reclosable closure means is preferably open in the preparation state and in the further preparation state and closed in the reclosure state. The reclosable closure means comprises a valve, for example, which is formed as part of the sealing element. Alternatively or in addition, the reclosable closure means comprises, for example, a region which is acted on with a restoring force and which opens and/or closes according to a pressure in the reservoir of the cartridge. The restoring force may be provided for example by means of a spring element. Alternatively or in addition, the reclosable closure means comprises a self-closing or reclosable diaphragm, for example.

In one preferred embodiment of the present invention, provision is made whereby the sealing element, in particular the sealing body of the sealing element, comprises a metal, preferably aluminum. It is alternatively or additionally conceivable that the sealing element, in particular the sealing body of the sealing element, comprises plastics material and/or tinplate and/or some other sheet metal. It is in particular conceivable that the sealing body or the sealing element is designed as a crimped cap.

In one embodiment of the present invention, it is possible for a sealing layer, in particular a lacquer and/or a laminated or coextruded plastics material, preferably comprising polypropylene and/or some other plastics material, to be arranged on an underside, directed toward the cartridge, of the sealing element, preferably of the sealing body. The sealing layer is arranged in particular between the cartridge wall and the sealing element. An advantageous sealing action can be realized by means of the sealing layer. It is optionally additionally or alternatively possible for a gasket to be arranged between the sealing element and the cartridge wall. It is for example conceivable for the gasket to be annular. It is alternatively conceivable for the gasket to be of full design, that is to say in particular in the form of a closed, preferably disc-shaped gasket. An additionally improved sealing action can be realized by means of the gasket.

In one embodiment of the present invention, it is possible for a protective lacquer to be applied to the top side, facing away from the cartridge, of the sealing element.

In one embodiment of the present invention, it is conceivable that the sealing element has an in particular rigid or semirigid sealing body having a pre-punched portion, in which a subregion of the sealing body has been partially punched. This means that the subregion has been not completely punched out of the sealing element but only partially punched out, such that, in the initial state of the cartridge, said subregion remains integrally connected, in its corner regions, to the rest of the sealing element. The reservoir thus remains hermetically sealed off in the initial state. It is conceivable that the sealing body is manufactured from one or more metals, in particular from aluminum. Other materials may also be used for manufacturing the sealing body.

In one embodiment of the present invention, it is conceivable that the reclosable region of the sealing element is formed by means of the pre-punched portion and/or by means of the subregion of the sealing body. The size of the punched portion preferably substantially corresponds to the passage opening that will later be produced in the sealing element by the spike. In an edge region of the subregion, the partial punching operation preferably forms a predetermined breaking point with respect to the rest of the sealing body, which predetermined breaking point at least partially tears when contact occurs between the subregion and a spike of the cartridge receptacle, in order to open up the passage opening in the preparation state of the cartridge system. After the subregion tears at the punched portion, the subregion can in particular also be understood as a flap. A restoring force preferably acts on the subregion, wherein the restoring force is provided for example by means of a spring. The restoring force ensures that, in the reclosure state after the preparation state, the subregion is moved in the direction of its initial position in the initial state of the cartridge system, such that the cartridge is closed by means of the subregion in the reclosure state.

In one embodiment of the present invention, it is alternatively conceivable that the pre-punched portion and/or the subregion of the sealing body is formed separately from the reclosable region and/or from the reclosable closure means, or that the pre-punched portion and/or the subregion is a region other than the reclosable region and/or the reclosable closure means. The size of the punched portion preferably substantially corresponds to the opening which will later be generated in the sealing element by the spike and through which the spike is led. In an edge region of the subregion, the partial punching operation preferably forms a predetermined breaking point with respect to the rest of the sealing body, which predetermined breaking point at least partially tears when contact occurs between the subregion and a spike of the cartridge receptacle. The spike is thus moved into its deployed position in a manner guided by the sealing element. The spike particularly preferably remains in its deployed position even in the reclosure state. In this embodiment, the dispensing of the beverage substance from the reservoir in the preparation state and in the further preparation state particularly preferably does not occur (or at least does not occur predominantly) via the subregion or directly at the spike, but rather occurs via the additionally provided reclosable region and/or the additionally provided reclosable closure means. For example, the reclosable closure means is in this case formed by a self-closing valve and/or a self-closing diaphragm.

In one embodiment of the present invention, it is conceivable that the passage opening of the sealing element, in particular of the sealing body, is formed either centrally or eccentrically in the sealing element, in particular in the sealing body. It is conceivable that the passage opening is closed by the reclosable region and/or the reclosable closure means of the sealing element in the initial state. The sealing body is in particular disk-shaped and/or annular. It is alternatively conceivable that the sealing body is likewise cup-shaped, wherein the encircling part protruding from the cup base is crimped around the cartridge wall. The part protruding from the cup base is in particular arranged on the outer side of the cartridge wall. It is preferably conceivable that that part of the sealing body which protrudes from the cup base and which is crimped around the cartridge wall is concealed by the cartridge receptacle. In one preferred embodiment of the present invention, provision is made whereby the sealing element comprises a crimped cap. It is for example conceivable that the sealing body of the sealing element is designed as a crimped cap. The sealing body, in its typical wall region, preferably has a wall thickness of between 0.09 and 0.5 millimeters, preferably between 0.1 and 0.3 millimeters, particularly preferably between 0.15 and 0.25 millimeters, and very particularly preferably of substantially 0.2 millimeters, in particular with an error tolerance of at most 15%.

In one preferred embodiment of the present invention, provision is made whereby the sealing element comprises a sealing foil. It is possible that the sealing foil comprises the reclosable region and/or the reclosable closure means.

In one preferred embodiment of the present invention, provision is made whereby the sealing foil comprises a plastics material foil, an aluminum foil or a multi-layer foil composed of plastics material and/or aluminum. It is alternatively or additionally conceivable that the sealing foil comprises a foam, a paper and/or other materials. A combination of plastics material and/or aluminum and/or paper and/or foam and/or further materials is also conceivable.

In one preferred embodiment of the present invention, provision is made whereby the sealing foil is fastened to the cartridge wall, wherein the sealing foil is preferably adhesively bonded, sealed and/or welded to the cartridge wall. Here, the sealing foil is preferably at least substantially flat when it has been attached to the cartridge. An encircling peripheral fastening region of the sealing foil is preferably adhesively bonded, sealed and/or welded to the cartridge wall.

In one preferred embodiment of the present invention, provision is made whereby the cartridge wall of the cartridge has an in particular encircling connecting means for connecting the cartridge to the cartridge receptacle or to an intermediate element between the cartridge and the cartridge receptacle, wherein the connecting means comprises in particular one or more detent beads and/or one or more detent ridges and/or one or more undercuts and/or an external thread. A stable and inexpensively producible connection between the cartridge and the cartridge receptacle is thus preferably achieved. It is particularly advantageously possible for the connecting means, in particular the detent means, to comprise a flattened region that forms an anti-rotation means of the cartridge and of the cartridge receptacle. It is conceivable that the cartridge has a flattened portion over its entire height, or that said cartridge is cylindrical (or has a circular area over its entire height).

In one preferred embodiment of the present invention, provision is made whereby the cartridge receptacle or the intermediate element comprises a counterpart connecting means that is in particular complementary with respect to the connecting means, in particular one or more further detent beads and/or one or more further detent ridges and/or one or more further undercuts and/or an internal thread, wherein the counterpart connecting means is connected preferably in form-fitting, frictional and/or cohesive fashion to the connecting means. It is alternatively or additionally conceivable that a wall of the cartridge receptacle is crimped around the cartridge. It is particularly advantageously possible for both the connecting means and the counterpart connecting means to each comprise a flattened region that forms an anti-rotation means of the cartridge and of the cartridge receptacle.

In one embodiment of the present invention, it is in particular conceivable that the cartridge receptacle is screwed by way of an internal thread and an external thread onto the cartridge. The screw connection is preferably configured to allow a screwing-on action with subsequent detent engagement, such that the detent engagement prevents subsequent unscrewing and/or makes it possible to achieve a set relative orientation of the cartridge receptacle with respect to the cartridge. For this purpose, an anti-rotation means, for example a vertical groove and/or a vertical projection and/or a vertical rib, may be formed on the cartridge and/or on the cartridge receptacle. A relative rotation of the cartridge and the cartridge receptacle with respect to one another can be prevented—when the cartridge and the cartridge receptacle are in the connected state—by the anti-rotation means.

In one preferred embodiment of the present invention, provision is made whereby the cartridge receptacle has a base structure that is manufactured at least partially and in particular entirely from plastics material. Inexpensive production is thus advantageously achieved.

In one preferred embodiment of the present invention, provision is made whereby the base structure has a cup-shaped form, the open side of which is oriented in the direction of the cartridge, wherein a beverage outlet opening and an outwardly open spike guide are formed on a base side situated opposite the cartridge, and wherein a fluid feed is formed on the base side or on a side wall of the main structure. This cartridge receptacle has the advantage that the fluid feed opens not into the reservoir of the cartridge but into the mixing chamber, which is separate from the reservoir. This prevents backward contamination of the beverage preparation machine through the fluid feed during the beverage-making process. For this purpose, the reservoir is not flushed through by the fluid, with the beverage substance and the fluid rather passing separately from one another into the mixing chamber of the cartridge receptacle. The fluid is conducted directly into the mixing chamber, whilst the beverage substance is transferred into the mixing chamber independently of the fluid. In particular, for this purpose, a movably mounted spike is arranged within the spike guide, wherein the spike is movable between a retracted position, in which the spike is spaced from the sealing element, and a deployed position, in which the spike extends through the sealing element and projects into the reservoir.

It is particularly preferably possible for the spike to be situated in the retracted position in the initial state of the cartridge system, such that the reservoir is in particular hermetically sealed off by the sealing element. To open the sealing element of the cartridge, the spike can then be transferred from the retracted position into the deployed position. In the deployed position, the spike opens the sealing element for example in its reclosable region, or the spike extends through, perforates or tears a different region of the sealing element. In the preparation state, the beverage substance can then pass out of the reservoir through the reclosable region and/or the reclosable closure means of the sealing element into the mixing chamber. A cartridge that was preferably previously closed in aroma-tight fashion can thus be easily and reliably opened in a beverage preparation machine. It has furthermore been found that backward contamination of the beverage preparation machine is prevented, in particular because no positive pressure that acts directly on the fluid feed is generated in the reservoir. After the process of preparing a beverage has been completed in the preparation state, the reclosable region and/or the reclosable closure means of the sealing element are closed again, and the cartridge system is thus transferred into a reclosure state. Here, it is possible both for the spike to remain in its deployed position and alternatively for the spike to be moved out of the reservoir and transferred for example into a retracted position. To prepare a further beverage, the beverage system is, after the reclosure state, transferred into a further preparation state, in which the reclosable region and/or the reclosable closure means are opened again such that beverage substance can be dispensed once again from the reservoir into the mixing chamber. The formation of the mixing chamber in the cartridge receptacle that is reversibly insertable into the beverage preparation machine advantageously ensures that the mixing chamber is part of the exchangeable cartridge system. In this way, contamination of the beverage preparation machine by the beverage substance is avoided in an effective manner, because only parts of the exchangeable single-use or multi-use cartridge system come into contact with the beverage substance.

In one preferred embodiment of the present invention, provision is made whereby the outer wall of the spike has at least one side channel for conducting the beverage substance in the direction of the mixing chamber when the sealing element has been pierced by the spike.

The side channel or side channels are particularly preferably arranged in the reclosable region of the sealing element in the preparation state and/or in the further preparation state.

In one preferred embodiment of the present invention, provision is made whereby the cartridge system and in particular the cartridge receptacle has at least one support structure that supports the sealing foil in the direction of the cartridge receptacle and in particular in the direction of the mixing cartridge. This prevents the sealing foil from being torn in particular when pressure is built up in the reservoir during the beverage-making process. The support structure comprises in particular a column-like, bridge-like, lattice-like or cylindrical structure which projects from the base of the mixing chamber in the direction of the reservoir and on which the sealing foil preferably partly lies.

In one preferred embodiment of the present invention, provision is made whereby the spike comprises a cylindrical or frustoconical base part and a piercing part which extends in the direction of the reservoir, wherein the piercing part is designed in the form of an obliquely truncated frustum. The piercing part is preferably furthermore designed such that an oblique cut surface of the obliquely truncated frustum substantially faces toward the reservoir, wherein the oval periphery of the cut surface at least partially constitutes a cutting edge for perforating the sealing element. It has been found that the cut surface that is generated by an oblique cut through the frustum firstly cuts the sealing element easily and with sufficiently little expenditure of force, and secondly does not separate any chips or loose pieces from the sealing element, which would otherwise undesirably contaminate the beverage. The perforation of the sealing element advantageously occurs with the material of the sealing element being severed with a smooth cut at that side of the spike where the cutting edge that protrudes furthest in the direction of the reservoir is formed, whereas, in the region of the cut surface of the piercing part, the cut-away material of the sealing element is still connected to the rest of the sealing element and remains present preferably in rolled-up or folded-together form or in the form of a flap.

The spike preferably comprises a frustoconical intermediate part arranged between the base part and the piercing part, wherein an encircling shoulder is formed between the base part and the intermediate part, and wherein an encircling edge is formed between the piercing part and the intermediate part. A stable spike is advantageously thus formed. The shoulder serves for abutting against a stop of the spike guide when the spike is in the deployed position, such that the deployment movement of the spike in the direction of the cartridge is limited.

It is conceivable that the cross section of the reclosable region and/or of the reclosable closure means (or the opening thereof) is adapted to the viscosity of the beverage substance, such that the reclosable region and/or the reclosable closure means control or limit the flow of the beverage substance in the direction of the mixing chamber. This is particularly advantageous in order to achieve constant portioning of the beverage substance that is introduced from the reservoir into the mixing chamber in the preparation state and in the further preparation state.

In one preferred embodiment of the present invention, provision is made whereby the spike has an anti-rotation means in the form of a rib which protrudes radially from the base part. A rotation of the spike as it is transferred from the retracted position into the deployed position is advantageously thus prevented.

In one preferred embodiment of the present invention, provision is made whereby the spike has a compressed-air line that is designed to generate a positive pressure in the reservoir of the cartridge in the preparation state, in particular during the preparation of the beverage, and in the further preparation state, in particular during the preparation of the further beverage. Compressed air can be blown into the reservoir through the compressed-air line, whereby the beverage substance is forced into the mixing chamber under pressure. In one preferred embodiment of the present invention, provision is made whereby the compressed-air line is a compressed-air line which is integrated into the spike and which is designed as a cartridge discharging device, wherein the compressed-air line extends along the spike in particular from a first end of the spike to a second end of the spike.

A compressed-air connection for connecting to a compressed-air source is preferably formed at the second end, and a compressed-air connection for blowing compressed air into the reservoir is preferably formed at the first end. Thus, in the context of the present invention, the cartridge discharging device integrated into the cartridge receptacle initially comprises only one compressed-air line, through which compressed air can be introduced into the reservoir from the outside. The cartridge receptacle is designed such that the beverage substance is forced from the reservoir into the mixing chamber by the compressed air. The compressed air is provided in particular by the beverage preparation machine.

In one preferred embodiment of the present invention, provision is made whereby the compressed-air connection is formed as an opening in the cut surface. This has the advantage that the discharging of the beverage substance into the mixing chamber is not impeded. Turbulence is thus preferably generated in the reservoir, said turbulence promoting the discharging of the beverage substance out of the reservoir.

The compressed-air connection is formed in particular as an opening in the base part, wherein the base part is arranged in the cartridge receptacle such that the compressed-air connection is accessible from outside the cartridge receptacle. This promotes the connection of the compressed-air line to the compressed-air source.

In one preferred embodiment of the present invention, provision is made whereby the spike guide has a guide part having an internal guide channel for receiving the spike, wherein the guide channel of the guide part is substantially cylindrical or frustoconical, and wherein, on an end of the guide part facing toward the cartridge, there is formed an encircling stop which limits the movement of the spike in the direction of the reservoir, wherein the stop comprises in particular a region of reduced diameter. Reliable guidance of the spike during the movement from the retracted position into the deployed position is advantageously thus achieved. A groove corresponding to the rib is preferably formed, as an anti-rotation means, within the wall of the guide channel, such that an undesired rotation of the spike is prevented. The guide part is preferably arranged in the mixing chamber, and in this case protrudes from a base of the mixing chamber in the direction of the cartridge.

In one preferred embodiment of the present invention, provision is made whereby the spike is formed as a plastics material part and in particular as an injection-molded plastics material part. Inexpensive production is thus made possible. It would however alternatively also be conceivable in principle for the spike to be formed as a metal part and/or from ceramic and/or from other suitable materials.

In a further preferred embodiment of the present invention, provision is made whereby the mixing chamber has a beverage outlet through which the beverage formed from a mixture of the beverage substance with the fluid is dispensed, wherein the cartridge system is preferably designed such that the beverage can be introduced from the beverage outlet directly into a portable vessel. It is advantageously thus the case that neither the beverage substance nor the beverage that is made comes into contact with any part of the beverage preparation machine, such that (backward) contamination of the beverage preparation machine is virtually entirely prevented. The fluid is fed separately to the mixing chamber. The fluid is preferably introduced under pressure into the mixing chamber. The fluid is provided in particular by the beverage preparation machine. It is conceivable that a fluid source is coupled directly to a corresponding fluid connection of the cartridge receptacle as soon as the cartridge system is inserted into the beverage preparation machine. A beverage and a further beverage can thus be prepared in the preparation state and in the further preparation state. In particular, the fluid comprises water, preferably pressurized, cooled and/or carbonated drinking water.

In one preferred embodiment of the present invention, provision is made whereby the mixing chamber is equipped with mixing structures. The mixing structures advantageously ensure improved mixing of beverage substance and fluid. For this purpose, the mixing structures are in particular configured such that turbulence is generated in the fluid that flows into the mixing chamber. It is conceivable that the mixing structure comprises one or more mixing ribs, which are arranged in the region of the fluid feed on the base of the mixing chamber and which extend substantially perpendicularly with respect to the inflow direction of the fluid. The mixing ribs thus function as barriers for the fluid, whereby turbulence is generated in the fluid and better mixing with the beverage substance is achieved.

In a further preferred embodiment of the present invention, provision is made whereby fluid that has been cooled by a cooling appliance is supplied to the fluid feed, wherein the cooling appliance is part of the beverage preparation machine or of a separate refrigerator that is operatively connected to the beverage preparation machine. Cold beverages can advantageously thus be made even if the cartridge has not been cooled and is for example at room temperature. The integration of the system into an existing refrigerator has the advantage that the existing cooling appliance of the refrigerator can easily and efficiently be jointly utilized for the beverage preparation machine. In particular in the case of so-called “side-by-side” refrigerators (often also referred to as American refrigerators), sufficient structural space for integrating the system is available in the front. It is conceivable that the beverage preparation machine is a retrofit kit for such a refrigerator. The cooling appliance preferably comprises a compressor cooling unit, an absorber cooling unit or a thermoelectric cooler.

In a further preferred embodiment of the present invention, provision is made whereby fluid that has had carbon dioxide mixed therewith by a carbonator is supplied to the fluid feed. It is conceivable for the carbonator to be part of the beverage preparation machine, wherein the carbonator has a receptacle for a CO₂ cartridge and has a feed device for mixing CO₂ from the CO₂ cartridge with the fluid. It is advantageously thus also possible for carbonated soft drinks to be made using the system. It would alternatively also be conceivable for the carbonator to have an external CO₂ connection.

The present invention furthermore relates to a beverage preparation machine comprising a cartridge system according to an embodiment of the present invention.

The cartridge system is preferably insertable into the beverage preparation machine. The beverage can be prepared in the preparation state of the cartridge in the beverage preparation machine, and a further beverage can be prepared in the further preparation state of the cartridge system in the beverage preparation machine. The cartridge system is particularly preferably not removed from the beverage preparation machine between the preparation state and the further preparation state. It is however alternatively conceivable that the cartridge system is removed from the beverage preparation machine in the reclosure state, after the preparation state, and is inserted into the beverage preparation machine again prior to the further preparation state.

The present invention furthermore relates to a method for producing a cartridge system according to an embodiment of the present invention, wherein the cartridge is formed in a first method step, wherein the sealing element is fastened to the cartridge in a second method step. Here, the sealing element is preferably fastened to the cartridge such that the cartridge is reclosable.

In one preferred embodiment of the present invention, in particular of the method for producing a cartridge system, provision is made whereby the cartridge is directly or indirectly connected to the cartridge receptacle in a third method step.

In one preferred embodiment of the present invention, in particular of the method for producing a cartridge system, provision is made whereby the cartridge receptacle is produced by injection molding of plastics material in an intermediate step performed before the third method step. It is advantageously thus the case that that part of the cartridge system which is not subjected to high pressure loading as a result of an introduction compressed air is manufactured from plastics material in an inexpensive production process, whereby the overall manufacturing costs can be kept low.

In one preferred embodiment of the present invention, in particular of the method for producing a cartridge system, provision is made whereby a spike is produced, and inserted into a spike guide of the cartridge receptacle, in a further intermediate step performed before or after the third method step.

In one preferred embodiment of the present invention, in particular of the method for producing a cartridge system, provision is made whereby the sealing element and/or a sealing body of the sealing element is partially or entirely punched and/or cut out of a metal sheet, in particular an aluminum sheet, and/or out of a sealing foil, preferably a plastics material foil, an aluminum foil or a multi-layer foil comprising plastics material and/or aluminum, in a further intermediate step performed before the second method step. If an aluminum sheet is used, the sheet is in particular then deep-drawn before or during the second method step such that the sealing body, formed from the aluminum sheet, of the sealing element, or the sealing element as a whole, preferably has in its typical wall region a wall thickness of between 0.09 and 0.5 millimeters, preferably between 0.1 and 0.3 millimeters, particularly preferably between 0.15 and 0.25 millimeters, and very particularly preferably of substantially 0.2 millimeters, in particular with an error tolerance of at most 15%.

In one preferred embodiment of the present invention, in particular of the method for producing a cartridge system, provision is made whereby the sealing element is crimped, adhesively bonded, sealed and/or welded to a cartridge wall of the cartridge during the second method step.

It is alternatively or additionally conceivable, in one embodiment of the present invention, in particular of the method for producing a cartridge system, that a passage opening is produced in the seal element, in particular drilled into the sealing element, in a further intermediate step, wherein the passage opening is closed in a later further intermediate step by the attachment of a reclosable closure means, for example by means of a valve. It is alternatively or additionally conceivable that a reclosable region, for example a flap, is produced in the sealing element, wherein the flap can be acted on with a restoring force. The restoring force may be provided for example by means of a spring.

Alternatively or in addition, in one embodiment of the present invention, in particular of the method for producing a cartridge system, it is conceivable that a connecting means, in particular a detent bead, a detent ridge, an undercut or an external thread, is formed in the cartridge wall during or after the first method step. Furthermore, in one embodiment of the present invention, in particular of the method, it is conceivable that a counterpart connecting means, in particular a detent bead, a detent ridge, an undercut or an internal thread, is produced on the cartridge receptacle before the third method step, and in particular during the injection molding of the cartridge receptacle. It is alternatively or additionally conceivable that a wall of the cartridge receptacle is crimped around the cartridge.

The cartridge or at least the in particular cup-shaped main body of the cartridge is preferably manufactured from glass in the first method step. It is however alternatively also conceivable for the cartridge to be manufactured from plastics material and/or from a metal, in particular aluminum. In the variant in which the main body or the cartridge is manufactured from aluminum, it is conceivable that the main body or the cartridge is produced by deep drawing or extrusion. The main body is preferably cup-shaped with a cylindrical cartridge wall that is closed on one side by a cartridge base, wherein the cartridge wall and the cartridge base are in particular formed as a single piece. It is conceivable that the cartridge wall and the cartridge base consist of a single piece, and preferably both consist of glass. It is alternatively also conceivable that the cartridge is manufactured from several individual parts. For example, it is conceivable that the cartridge wall and the cartridge base are separate parts, which are connected, in particular sealingly, to one another for example in the first method step.

The present invention furthermore relates to a method for using a cartridge system according to an embodiment of the present invention for making a beverage.

In one preferred embodiment of the present invention, in particular of the method for using a cartridge system, provision is made whereby
the cartridge is closed in an initial state of the cartridge system,
the cartridge is transferred into a preparation state of the cartridge system in a first use step, wherein the cartridge is open, in particular such that a fluidic connection between the reservoir and the mixing chamber is formed, in the preparation state of the cartridge system, wherein the beverage is prepared in the preparation state of the cartridge system,
the cartridge is transferred into a reclosure state of the cartridge system in a second use step, in particular after the preparation state, wherein the cartridge is closed in the reclosure state of the cartridge system.

In one preferred embodiment of the present invention, in particular of the method for using a cartridge system, provision is made whereby the cartridge is transferred into a further preparation state of the cartridge system in a third use step, in particular after the reclosure state, wherein the cartridge is open, in particular such that a fluidic connection between the reservoir and the mixing chamber is formed, in the further preparation state of the cartridge system, wherein a further beverage is prepared in the further preparation state of the cartridge system. The cartridge system is preferably not removed from the beverage preparation machine between the first use step and the third use step. It is however conceivable that the cartridge system is removable from the beverage preparation machine in the reclosure state, that is to say between the first use step and the third use step.

In one preferred embodiment of the present invention, in particular of the method for using a cartridge system, provision is made whereby the cartridge system has a movable spike,
wherein the spike is movable between a retracted position, in which the spike is spaced from the sealing element, and a deployed position, in which the spike pierces the sealing element and projects into the reservoir,
wherein the spike is situated in its retracted position in the initial state of the cartridge system,
wherein the spike is moved into the deployed position in the first use step, in particular such that the spike is situated in its deployed position in the preparation state of the cartridge system.

In one preferred embodiment of the present invention, in particular of the method for using a cartridge system, provision is made whereby the spike is moved into its retracted position in the second use step, in particular such that the spike is situated in its retracted position in the reclosure state of the cartridge system, wherein the spike is preferably moved into its deployed position in the third use step, in particular such that the spike is situated in its deployed position in the further preparation state of the cartridge system.

Alternatively, in one preferred embodiment of the present invention, in particular of the method for using a cartridge system, provision is made whereby the spike remains in its deployed position in the second use step and preferably in the third use step, in particular such that the spike is situated in its deployed position in the reclosure state of the cartridge system and preferably in the further preparation state of the cartridge system.

In one preferred embodiment of the present invention, in particular of the method for using a cartridge system, provision is made whereby the sealing element comprises a reclosable region and/or a reclosable closure means,
wherein the reclosable region and/or the reclosable closure means is closed in the initial state of the cartridge system,
wherein the reclosable region and/or the reclosable closure means is open in the first use step, wherein the reclosable region and/or the reclosable closure means is open, in particular such that the fluidic connection between the reservoir and the mixing chamber is formed by means of the reclosable region and/or the reclosable closure means, in the preparation state of the cartridge system,
wherein the reclosable region and/or the reclosable closure means is closed in the second use step, wherein the reclosable region and/or the reclosable closure means is closed in the reclosure state of the cartridge system,
wherein the reclosable region and/or the reclosable closure means is open in the third use step, wherein the reclosable region and/or the reclosable closure means is open, in particular such that the fluidic connection between the reservoir and the mixing chamber is formed by means of the reclosable region and/or the reclosable closure means, in the further preparation state of the cartridge system.

The advantages and developments that have already been described in conjunction with the cartridge system according to the invention or in conjunction with an embodiment of the cartridge system according to the invention can be applied to the method according to the invention for producing a cartridge system, to the beverage preparation machine according to the invention, and to the method according to the invention for using a cartridge system. The advantages and developments that have already been described in conjunction with the beverage preparation machine according to the invention or in conjunction with an embodiment of the beverage preparation machine according to the invention can be applied to the cartridge system according to the invention, to the method according to the invention for producing a cartridge system, and to the method according to the invention for using a cartridge system. The advantages and developments that have already been described in conjunction with the method according to the invention for producing a cartridge system or in conjunction with an embodiment of the method according to the invention for producing a cartridge system can be applied to the cartridge system according to the invention, to the beverage preparation machine according to the invention, and to the method according to the invention for using a cartridge system. The advantages and developments that have already been described in conjunction with the method according to the invention for using a cartridge system or in conjunction with an embodiment of the method according to the invention for using a cartridge system can be applied to the cartridge system according to the invention, to the beverage preparation machine according to the invention, and to the method according to the invention for producing a cartridge system.

Further details, features and advantages of the invention will emerge from the drawings and from the following description of preferred embodiments on the basis of the drawings. Here, the drawings illustrate merely exemplary embodiments of the invention, which do not restrict the essential concept of the invention.

### BRIEF DESCRIPTION OF THE DRAWINGS

FIGS. 1a, 1b, 1c, 1d and 1e show a perspective illustration and schematic sectional views for illustrating the general functional principle of a cartridge system according to an exemplary first embodiment of the present invention.

FIGS. 2a, 2b, 2c, 2d and 2e show a perspective illustration and schematic sectional views for illustrating the general functional principle of a cartridge system according to an exemplary second embodiment of the present invention.

FIG. 3 shows a schematic sectional view of the mouth region of a cartridge having a sealing element according to an exemplary embodiment of the present invention.

FIG. 4 shows a schematic sectional view of the mouth region of a cartridge having a sealing element according to an exemplary embodiment of the present invention.

FIG. 5 shows a schematic sectional view of the mouth region of a cartridge having a sealing element according to an exemplary embodiment of the present invention.

FIG. 6 shows a schematic sectional view of the mouth region of a cartridge having a sealing element according to an exemplary embodiment of the present invention.

FIGS. 7a, 7b and 7c show schematic perspective views of a sealing element having a reclosable closure means in an initial state, in a preparation state and in a reclosure state of the cartridge system.

### EMBODIMENTS OF THE INVENTION

Identical parts are always denoted by the same reference designations in the various figures, and will therefore generally also each be designated or mentioned only once.

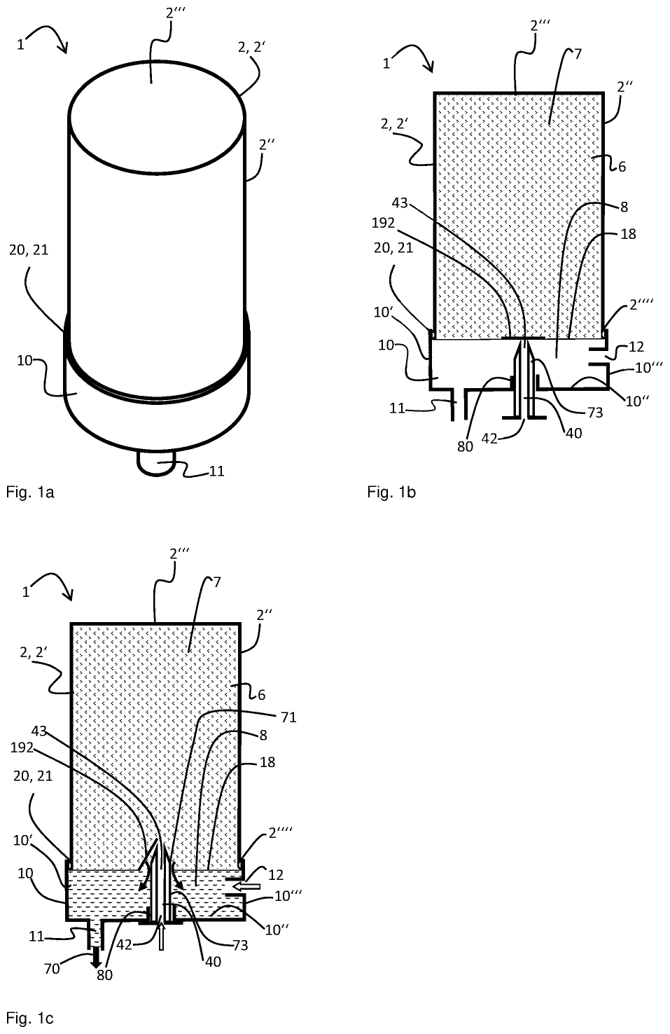

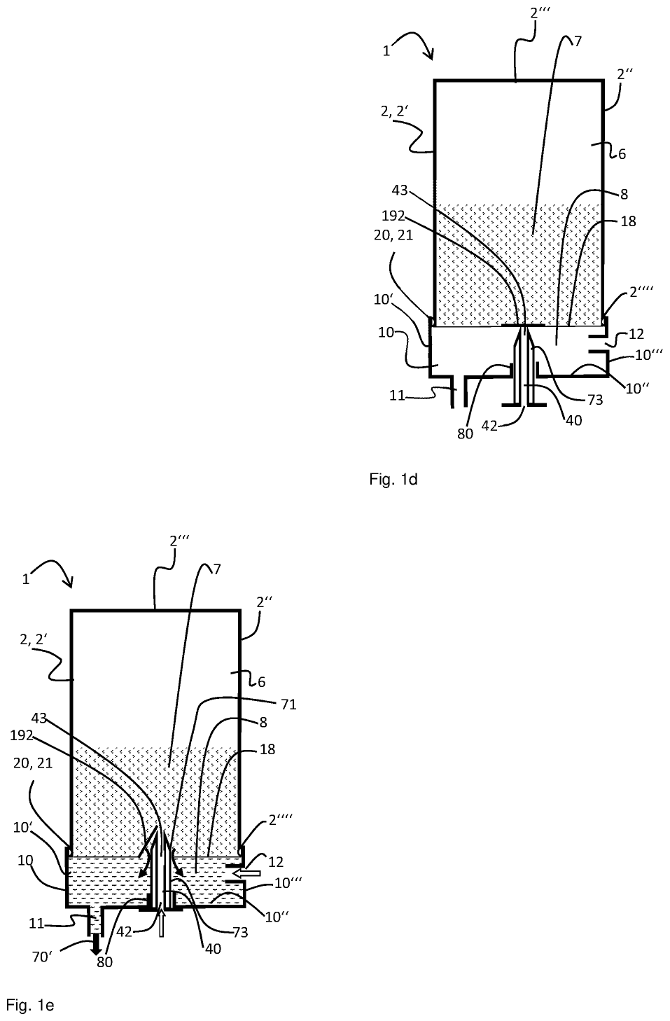

FIG. 1a is a perspective illustration of a cartridge system 1 according to a first exemplary embodiment of the present invention. FIG. 1b is a sectional illustration of the cartridge system 1 according to the first exemplary embodiment in its initial state. FIG. 1c is a sectional illustration of the cartridge system 1 according to the first exemplary embodiment in its preparation state. FIG. 1d is a sectional illustration of the cartridge system 1 according to the first exemplary embodiment in its reclosure state. FIG. 1e is a sectional illustration of the cartridge system 1 according to the first exemplary embodiment in its further preparation state. The cartridge system 1 comprises a cartridge 2. The cartridge 2 comprises a cup-shaped hollow main body 2′, which forms a reservoir 6 for a beverage substance 7. Here, “cup-shaped” means that the main body 2′ has a cartridge base 2″′ and a cartridge wall 2″ that protrudes at right angles from the cartridge base 2″′, in particular in the direction of the cartridge receptacle 10. Here, the cartridge wall 2″ is at least partially of cylindrical and encircling form, whilst the cartridge base 2″′ is for example of circular design. The main body 2′ of the cartridge 2, or the cartridge 2 itself, is preferably formed by, or at least by means of, a glass bottle. The reservoir 6 of the cartridge 2 can be filled with a beverage substance 7.

On a side situated opposite the cartridge base 2″′ in an axial direction, the cartridge 2 has an opening 90 that can be closed by means of a sealing element 18. The sealing element 18 is in particular attachable to the cartridge wall 2′ of the cartridge 2, in particular by crimping, adhesive bonding, sealing and/or welding. The cartridge 2 furthermore comprises a connecting means 20, which is formed for example by a detent ridge, a detent bead or a thread. The connecting means 20 is designed to connect the cartridge 2 to a cartridge receptacle 10 or to an intermediate element that is arranged between the cartridge 2 and the cartridge receptacle 10. The cartridge 2 and in particular the connecting means 20 preferably comprises an anti-rotation means for fixing an orientation between the cartridge 2 and the cartridge receptacle 10. An anti-rotation means for the cartridge 2 and the cartridge receptacle 10 is preferably formed by the connecting means 20 and/or by further elements. It is conceivable that the cartridge wall 2″ and the cartridge receptacle 10 are additionally adhesively bonded, welded and/or pressed together. In particular, it is conceivable that an additional seal is formed between the cartridge 2 and the cartridge receptacle 10, for example by means of an O-ring, which is arranged in particular in the region of the connecting means 20. Alternatively or in addition, the additional seal may be implemented for example by virtue of the cartridge receptacle 10 being formed using a two-component plastics material. In this way, an advantageous seal can preferably be implemented even if the cartridge wall has a relatively large tolerance of for example ±0.3 mm.

The cartridge 2 is fixedly or reversibly connected to the cartridge receptacle 10. The cartridge receptacle 10 is connected to the cartridge 2 in particular after the production of the main body 2′, after the filling of the cartridge 2 with the beverage substance 7, and after and/or during the closing of the reservoir 6 by the application of the sealing element 18.

The cartridge 2 is preferably designed to withstand an internal pressure of up to 12 bar, preferably up to 10 bar, particularly preferably up to 8 bar, and very particularly preferably up to 6 bar, without rupturing (at a temperature of 20° C. and an ambient pressure of 1 bar). Here, the reservoir 6 preferably has a volume of between 10 and 500 milliliters, particularly preferably between 30 and 200 milliliters.

The cartridge system 1 that is shown is provided for being inserted into a beverage preparation machine (not illustrated) in order to prepare, preferably, at least one beverage 70 and one further beverage 70′. For this purpose, the cartridge 2 is filled with a beverage substance 7. For the preparation of at least two beverages, the beverage substance 7 comprises at least two portions.

Within the beverage preparation machine, corresponding beverages 70, 70′ are made by means of the beverage substance 7 and an additional water source, hereinafter referred to as fluid source 41. Here, the cartridge 2 is preferably filled with a pre-portioned quantity of beverage substance 7 that is preferably required to make at least two specific drink portions, for example two full drinking glasses of the desired beverage 70. The beverage substance 7 is in particular a liquid beverage concentrate which contains carbonic acid and which is in the form of syrup.

In principle, there are in particular a multiplicity of different cartridge systems 1 available, the cartridges 2 or reservoirs 6 of which are filled with different beverage substances 7 for the purposes of making different beverages 70, 70′. If the user of the system 1 wishes to drink a particular beverage 70, said user merely has to choose, from the multiplicity of different cartridge systems 1, that cartridge system 1 which contains the corresponding beverage substance 7 for making the desired beverage 70, insert said cartridge system into a holding unit of the beverage preparation machine, and start the beverage-making process on the beverage preparation machine, for example by pressing a start button, correspondingly touching a touch-sensitive display, by gesture or speech control, or using a suitable application on a mobile telephone. It is also conceivable that the beverage-making process starts automatically when it is detected that a new cartridge system 1 has been placed into the holding unit. In each of the aforementioned cases, the desired beverage 70 is then automatically made, conducted into a drinking vessel and thus made available to the user. After the beverage 70 has been prepared, a further beverage 70′ can be made using the same cartridge system 1. After the designated number of beverages has been made using the cartridge system, the consumed cartridge system 1 is subsequently removed and disposed of. The beverage preparation machine is then ready again to be filled with any desired new cartridge system 1.

The beverage substance 7 preferably comprises liquid premix constituents for soft drinks, such as caffeinated, carbonated, fruit-containing and/or sugar-containing lemonades and juices, (mixed) beer beverages or other alcoholic or non-alcoholic (mixed) beverages.

The cartridge receptacle 10 has a mixing chamber 8 which, during the beverage-making process, in particular in the preparation state and in the further preparation state of the cartridge system 1, is fluidically connected to the reservoir 6 such that the beverage substance 7 can be at least partially transferred from the reservoir 6 into the mixing chamber 8 by means of a cartridge discharging device of the cartridge receptacle 10. For this purpose, the cartridge discharging device comprises a compressed-air line 40. One end of the compressed-air line 40 is connected to a compressed-air connection 42, which can be connected to a compressed-air source of the beverage preparation machine for the purposes of introducing compressed air into the compressed-air line 40, whilst the other end opens into a compressed-air outlet which is open in the direction of the reservoir 6 and which introduces compressed air into the reservoir 6. The introduction of the compressed air causes the beverage substance 7 to be forced into the mixing chamber 8. It is conceivable that the compressed-air line 40 extends in the interior of the spike 73 from the outer compressed-air connection 42, for connecting to a compressed-air source, to a compressed-air outlet 43, in the region of a tip of the spike.

Furthermore, a fluid feed 12 of the cartridge receptacle 10 opens into the mixing chamber 8, to which fluid feed a supply is provided by a fluid source of the beverage preparation machine. It is conceivable that the fluid feed has a quick-action coupling by means of which the fluid guide 12 can be attached to the fluid source of the beverage preparation machine. The quick-action coupling may for example be designed such that a fluidic connection between the fluid source and the mixing chamber 8 is automatically established via the fluid guide 12 when the cartridge system 1 is inserted into the holding unit. Fluid, in particular cooled and carbonated drinking water, passes via said fluidic connection from the fluid feed 12 into the mixing chamber 8 during the beverage-making process, in particular during the preparation state and the further preparation state of the cartridge system 1. Furthermore, beverage substance 7 passes from the reservoir 6 into the mixing chamber 8 during the beverage-making process, in particular during the preparation state and the further preparation state of the cartridge system 1, as described above. Mixing of the beverage substance 7 with the fluid in the mixing chamber 8 causes the corresponding beverages 70, 70′ to be made, which then exit the mixing chamber 8 through a beverage outlet 11.

The cartridge receptacle 10 has the beverage outlet 11, through which the beverages 70, 70′ that are made within the mixing chamber 8 exit the mixing chamber 8 and are in particular conducted directly into corresponding drinking vessels (not shown), that is to say without parts of the beverage preparation machine coming into contact with the beverages. Backward contamination of the beverage preparation machine is thus prevented. The drinking vessels are in particular arranged directly underneath the beverage outlet 11. The cartridge receptacle 10 comprises a base structure 10′ of cup-shaped form. The open side of said cup-shaped form points in the direction of the cartridge 2 and at least partially receives the cartridge 2, in particular the edge 2″″ of the cartridge wall 2″. On an oppositely situated bottom side 10″, the base structure 10′ has the beverage outlet opening 11 and the outwardly open spike guide 80. The fluid feed 12 is formed on a side wall 10″″ of the base structure 10′. The base structure 10′ is formed in particular as a plastics material part and particularly preferably as an injection-molded plastics material part.

After all beverage-making processes for which the cartridge system 1 is intended have been completed, the cartridge system 1 is removed from the holding unit, such that the beverage-making machine can be fitted with a new and unconsumed cartridge system 1. The cartridge receptacle 10 may optionally be reused by being separated from the used cartridge 2, for example by virtue of the detent connection being released, and clipped onto a new cartridge 2. It is conceivable that the cartridge 2 can also be reused. In particular, it is conceivable that the cartridge can be filled with a new beverage substance 7 and sealed off by means of a sealing element 18.

The cartridge 2 is preferably hermetically sealed off by the sealing element 18 in an initial state of the cartridge system, that is to say before the preparation of the beverage 70 is commenced. After the cartridge system 1 has been inserted into the beverage preparation machine, the preparation of the beverage 70 can then be commenced. For this purpose, the cartridge system 1 is transferred from its initial state into a first preparation state. The sealing element 18 comprises a reclosable region 192, which is formed in particular by a pre-punched portion and which can be opened, in particular pierced, and for example pivoted away, by a spike 73 of the cartridge system. For this purpose, the spike 73 is mounted movably in the spike guide 80. The sealing element 18 is opened, for example pierced, by virtue of the movable spike 73 being transferred between a retracted position, in which the spike 73 is spaced from the sealing element 18 (cf. FIG. 1b), and a deployed position, in which the spike 73 extends through the sealing element 18 (cf. FIG. 1c) and projects into the reservoir 6. In this way, the cartridge system 1 is transferred into a preparation state, in which a beverage can be prepared (cf. FIG. 1c). The spike 73 is formed preferably as a plastics material part and particularly preferably as an injection-molded plastics material part.

The outer wall of the spike 73 is equipped with the plurality of side channels 71 for conducting the beverage substance 7 from the reservoir 6 toward the mixing chamber 8 when the sealing element 18 has been opened. The side channels 71 are configured for example in the form of grooves which run parallel to one another and which are open at one side. Once the sealing element 18 has extended through the reclosable region 192, a fluidic connection is established between the side channels 71 and the reservoir 6 such that the beverage substance 7 can flow in the direction of the mixing chamber 8.

The cross section of the side channels 71 and/or the number of side channels 71 is in this case preferably adapted to the viscosity of the beverage substance 7, such that the side channels 71 control or limit the flow of the beverage substance 7 in the direction of the mixing chamber 8. A relatively large number of side channels 71 and/or side channels 71 of relatively large cross section are used in the case of a high viscosity, whereas relatively few side channels 71 and/or side channels 71 of relatively small cross section are provided in the case of a low viscosity.

Also integrated into the spike 73 is the compressed-air guide 40, which functions as a cartridge discharging device. The compressed-air line 40 opens, at the end of the spike 73, into the reservoir 6 when the spike 73 is situated in the deployed position. The compressed-air connection 42 is formed at a side of the spike 73 which in particular faces away from the reservoir 6, and said compressed-air connection is thus accessible from outside the cartridge receptacle 10 and can be connected to the compressed-air source of the beverage preparation machine.

It is preferably conceivable that the fluid source and the compressed-air source are coupled directly to the fluid feed 12 and to the compressed-air connection 42 respectively as soon as the cartridge system 1 is inserted into the beverage preparation machine or a beverage-making process is started, and in particular before the sealing element 18 is pierced. In this way, backward contamination in the direction of the beverage preparation machine is avoided in an effective manner, because the fluid feed 12 and the cartridge discharging device are in particular positively pressurized immediately upon the insertion of the cartridge system 1, thus preventing beverage substance 7 from migrating in the direction of the fluid source or compressed-air source. The beverage substance 7 can thus move from the reservoir 6 only in the direction of the mixing chamber 8 (see FIG. 1c) as soon as the sealing element 18 is opened.

The beverage 70 is prepared in the preparation state according to FIG. 1c. Here, only a first portion of the beverage substance 7 is dispensed out of the reservoir 6 of the cartridge, whilst at least a second portion of the beverage substance 7 remains in the reservoir 6. In particular after the preparation of the beverage 70 has been completed, the cartridge system 1 is transferred into a reclosure state by virtue of the spike 73 being transferred into its retracted position, with the reclosable region 192 being closed. In particular, in the process, the flap of the sealing element 18 is pushed back in the direction of its original position in the initial state by a restoring force. The restoring force may for example be provided by means of a spring that is arranged on the flap (not illustrated). Alternatively or in addition, the restoring force may be generated by the flap itself or by the transition of the flap to the rest of the sealing element 18, such that the flap is automatically pushed back into its initial position. FIG. 1d shows the reclosure state of the cartridge system 1. It is conceivable that the sealing of the cartridge 2 by the sealing element 18 and in particular by the flap of the sealing element 18 in the reclosure state is of lower quality than that in the initial state. For example, it is possible that the sealing achieved in the reclosure state by means of the sealing element 18 is not fully gas-tight, and/or that, even in the reclosure state, individual droplets of the beverage substance 7 emerge from the reservoir 6, in particular slowly. Only a proportion of the original beverage substance, in particular a second portion, is present in the reservoir 6 in the reclosure state. It is conceivable that the flap, that is to say in particular the reclosable region 192, comprises an additional gasket that assists in improving the sealing action in the reclosure state.

After a further drinking vessel has been arranged on the beverage preparation machine, for example, the cartridge 1 is transferred from the reclosure state into a further preparation state (cf. FIG. 1e) for the purposes of preparing a further beverage 70′. Here, the spike 73 is transferred from its retracted position into the deployed position, wherein the spike 73 opens the reclosable region 192 of the sealing element 18 and projects into the reservoir 6. A fluidic connection intended for the preparation of the further beverage 70′ is accordingly established again between the reservoir 6 and the mixing chamber 8. The further beverage 70′ is then prepared by means of the fluid source, the compressed-air source and the second portion of the beverage substance 7.

It is conceivable that the beverage substance 7 comprises more than two portions, for the purposes of preparing more than two beverages 70, 70′. In this case, the system can be transferred into a further reclosure state and into a yet further preparation state, corresponding to FIGS. 1d and 1e.

It is conceivable that the reclosable region 192 comprises—in particular instead of a pre-punched portion and a flap—a reclosable, in particular self-closing diaphragm, which can be pierced and opened by the spike 73 and which closes again when the spike 73 is transferred into its retracted position. It is conceivable that the sealing element 18 is formed entirely or partially by such a reclosable diaphragm. It is for example conceivable that the reclosable diaphragm is fastened to a semirigid or rigid sealing body 19 of the sealing element 18.

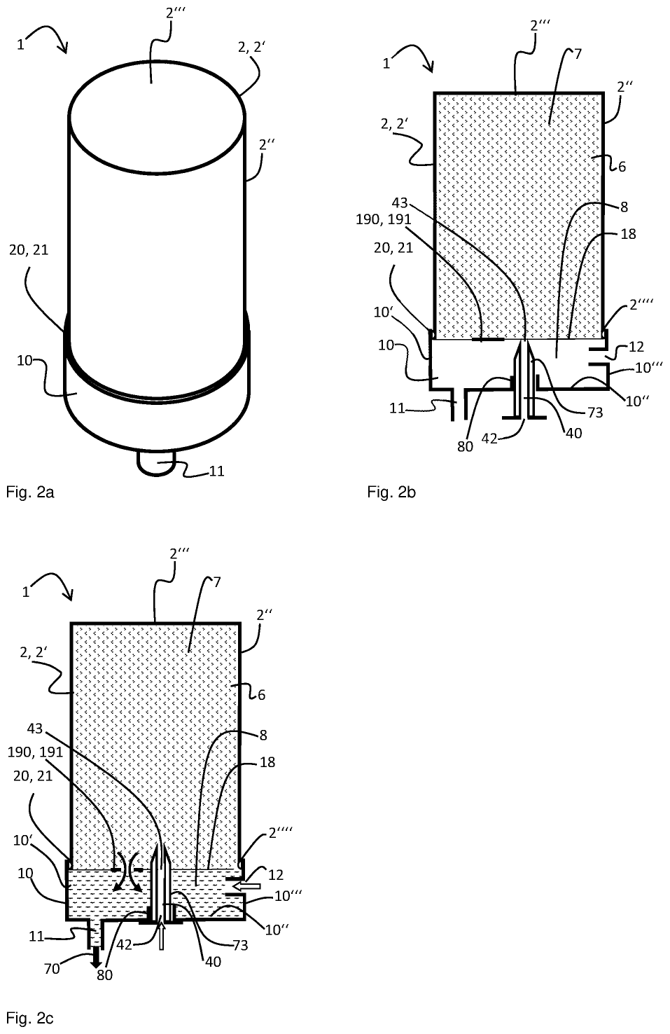

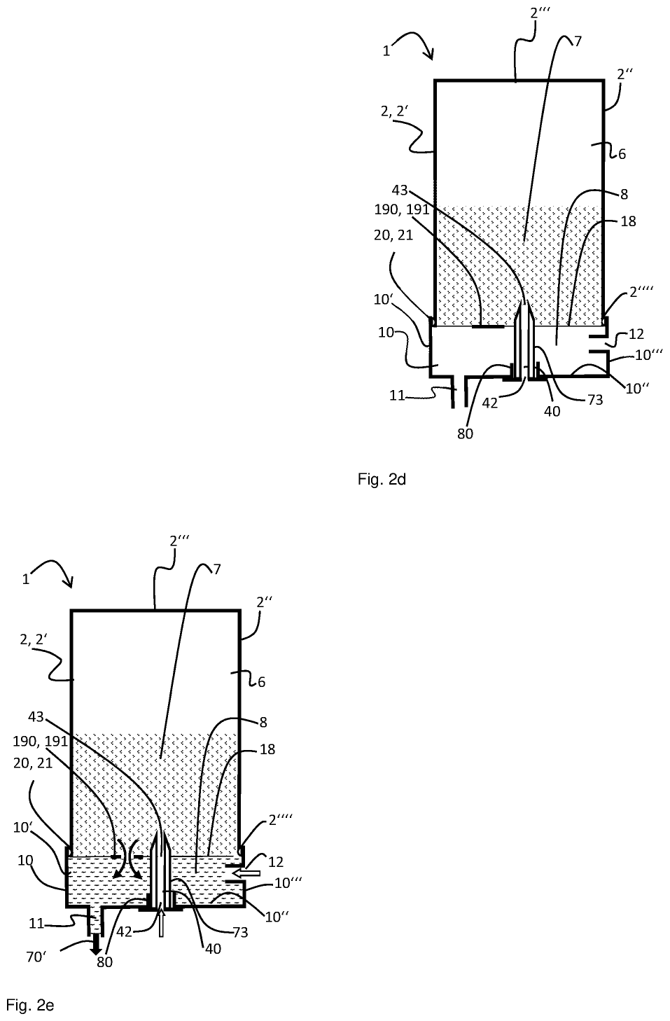

FIG. 2a is a perspective illustration of a cartridge system 1 according to a second exemplary embodiment of the present invention. FIG. 2b is a sectional illustration of the cartridge system 1 according to the second exemplary embodiment in its initial state. FIG. 2c is a sectional illustration of the cartridge system 1 according to the second exemplary embodiment in its preparation state. FIG. 2d is a sectional illustration of the cartridge system 1 according to the second exemplary embodiment in its reclosure state. FIG. 2e is a sectional illustration of the cartridge system 1 according to the second exemplary embodiment in its further preparation state.

By contrast to the first exemplary embodiment according to FIGS. 1a to 1e, the sealing element 18 according to the second exemplary embodiment comprises a reclosable closure means 190, which is designed in particular as a valve 191. In the initial state of the cartridge system 1 (cf. FIG. 2b), the spike 73 is situated in its retracted position. In order to transfer the cartridge system 1 from the initial state into the preparation state (cf. FIG. 2c), the spike 73 is transferred into its deployed position. In the process, the spike 73 extends through, and opens, the sealing element 18. For example, the sealing element 18 is pierced or perforated by the spike 73. The sealing element 18 comprises, for example, a rigid or semirigid sealing body 19. The spike 73 pierces the sealing element 18 for example in a subregion that is equipped with a pre-punched portion for this purpose. It is alternatively also possible that the sealing element 18 comprises a sealing foil 18″, wherein the spike 73 pierces the sealing foil 18″. Here, the spike 73 particularly advantageously extends through the sealing element 18 in a region of the sealing element 18 other than the reclosable closure means 190.

In this embodiment, the spike 73 preferably has no side channels. It is preferably the case that no beverage substance 7 flows from the reservoir 6 into the mixing chamber 8 via the spike 73, or directly at the spike 73, during the preparation of a beverage (that is to say in particular in the preparation state and/or in the further preparation state).

During the preparation of a beverage in the preparation state, the beverage substance 7 is partially transferred from the reservoir 6 into the mixing chamber 8 by means of a cartridge discharging device of the cartridge receptacle 10. For this purpose, the cartridge discharging device comprises a compressed-air line 40, by means of which a positive pressure is generated in the reservoir 6. The reclosable closure means 190, in particular the valve 191, particularly preferably opens owing to the pressure that is generated in the reservoir 6 by means of the compressed-air line 40. A liquid connection between the reservoir 6 and the mixing chamber 8 is thus established through the reclosable closure means 190, in particular the valve 191, via which liquid connection a first portion of the beverage substance 7 passes from the reservoir 6 into the mixing chamber 8 during the preparation of the beverage 70. The beverage 70 is thus prepared by means of the fluid that is provided via the fluid feed 12 of the cartridge receptacle 10.

In particular, after the preparation of the beverage 70 has been completed, the cartridge system 1 is transferred into the reclosure state (cf. FIG. 2d). Here, in particular, the pressure that has been built up in the reservoir 6 by means of the compressed-air line 40 is reduced, such that the valve 191 closes. The spike 73 preferably remains in its deployed position even in the reclosure state. In the reclosure state, the cartridge 6 is closed by means of the sealing element 18. It is conceivable here that the leak-tightness of the cartridge 2 in the reclosure state corresponds, or is at least similar, to the leak-tightness in the initial state. It is however alternatively also possible that the leak-tightness of the cartridge in the reclosure state is reduced in relation to the leak-tightness of the cartridge 2 in the initial state. For example, it is conceivable that the cartridge 2 is not fully hermetically sealed in the reclosure state, and that, in particular, gases can ingress into the cartridge 2 and/or can escape from the cartridge 2, or individual droplets of the beverage substance 7 can pass from the reservoir 6 into the mixing chamber 8.

After a further drinking vessel has been arranged on the beverage preparation machine, for example, the cartridge 1 is transferred from the reclosure state into a further preparation state (cf. FIG. 2e) for the purposes of preparing a further beverage 70′. Here, a positive pressure is built up in the reservoir 6 again by means of the pressure line 40, and the valve 191 is opened. A connection required for the preparation of the further beverage 70′ is accordingly established again between the reservoir 6 and the mixing chamber 8, through which connection the beverage substance 7 can pass into the mixing chamber 8. The further beverage 70′ is then prepared by means of the fluid source, the compressed-air source and the second portion of the beverage substance 7.

It is conceivable that the beverage substance 7 comprises more than two portions, for the purposes of preparing more than two beverages. In this case, the system can be transferred into a further reclosure state and into a yet further preparation state, corresponding to FIGS. 2d and 2e.

It is furthermore conceivable that, in the initial state of the cartridge system 1, the sealing element 18 is additionally sealed off in the region of the reclosable closure means 190, in particular of the valve 191, by means of a sealing foil 18″. Said sealing foil 18″ is preferably pierced and/or torn open during the transfer into the preparation state. Improved leak-tightness is thus realized in the initial state, which is for example advantageous for the storage of the beverage substance in the cartridge 2 prior to the preparation of a beverage.

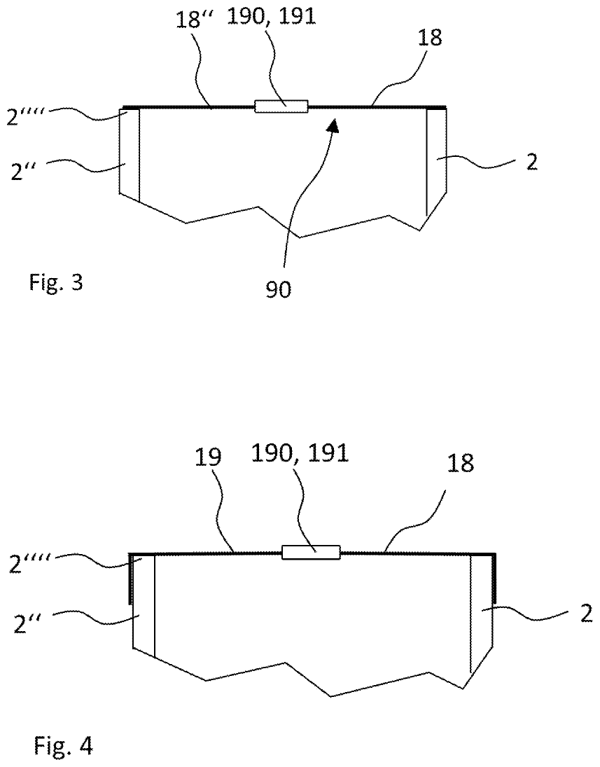

FIG. 3 shows a schematic sectional view of the mouth region of a cartridge 3 having a sealing element 18 according to an exemplary embodiment of the present invention. The opening 90 of the cartridge 2 is closed by a sealing element 18. The sealing element 18 is designed as a sealing foil 18″ and comprises a reclosable closure means 190, in particular a valve 191. The sealing foil 18″ is fastened, in particular adhesively bonded, sealed and/or welded, to the edge 2″″ of the cartridge wall 2″.

FIG. 4 shows a schematic sectional view of the mouth region of a cartridge 3 having a sealing element 18 according to an exemplary embodiment of the present invention. The opening 90 of the cartridge 2 is closed by a sealing element 18 that comprises a rigid or semirigid sealing body 19. The sealing element 18 comprises a reclosable closure means 190, in particular a valve 191. The sealing body 19 is fastened, in particular crimped, adhesively bonded, sealed and/or welded, to the edge 2″″ of the cartridge wall 2″.

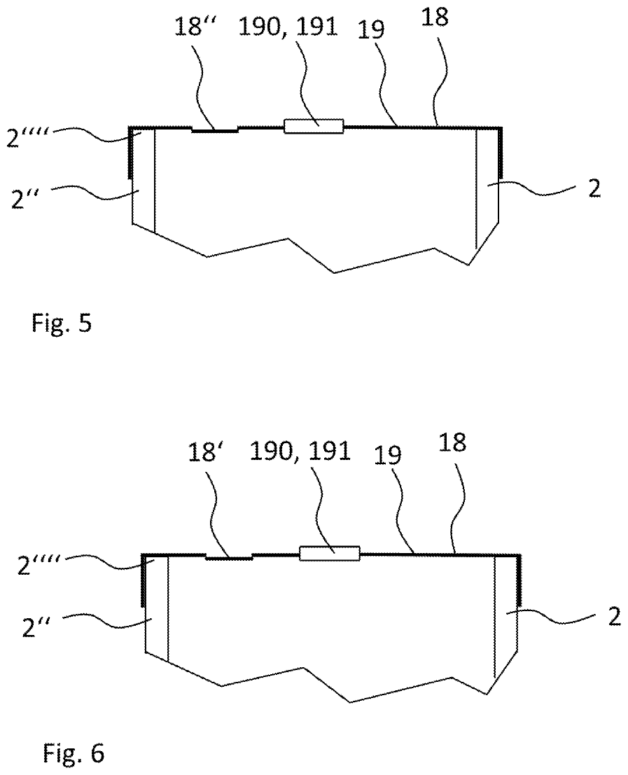

FIG. 5 shows a schematic sectional view of the mouth region of a cartridge 3 having a sealing element 18 according to an exemplary embodiment of the present invention. The opening 90 of the cartridge 2 is closed by a sealing element 18 that comprises a rigid or semirigid sealing body 19. The sealing element 18 comprises a reclosable closure means 190, in particular a valve 191. The sealing body 19 is fastened, in particular crimped, adhesively bonded, sealed and/or welded, to the edge 2″″ of the cartridge wall 2″. The sealing element 18 additionally comprises a sealing foil 18″, which is preferably fastened to the sealing body 19. The sealing foil 18″ can be pierced, in particular torn open, by a spike 73.

FIG. 6 shows a schematic sectional view of the mouth region of a cartridge 3 having a sealing element 18 according to an exemplary embodiment of the present invention. The opening 90 of the cartridge 2 is closed by a sealing element 18 that comprises a rigid or semirigid sealing body 19. The sealing element 18 comprises a reclosable closure means 190, in particular a valve 191. The sealing body 19 is fastened, in particular crimped, adhesively bonded, sealed and/or welded, to the edge 2″″ of the cartridge wall 2″. The sealing body 19 additionally comprises a pre-punched portion 18′ that can be pierced by a spike 73.

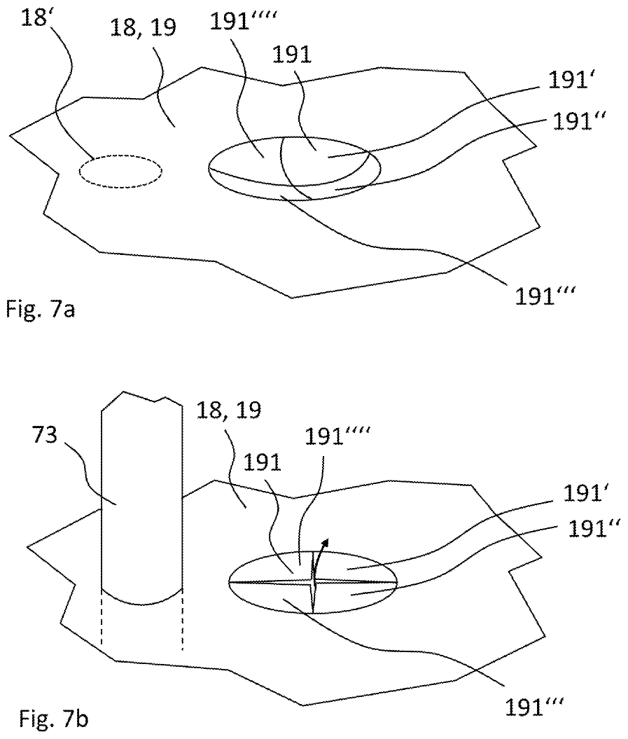

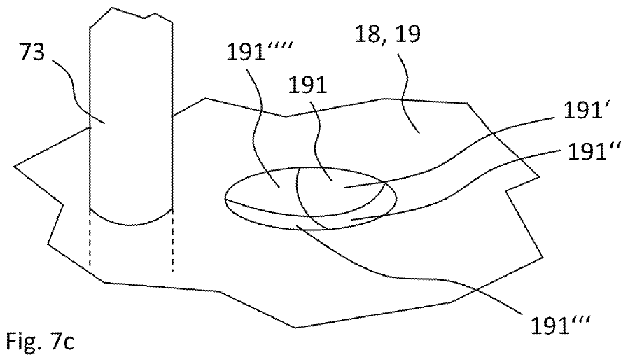

FIG. 7a shows a schematic perspective view of a sealing element 18 having a reclosable closure means 190 in an initial state of the cartridge system 1. The reclosable closure means 190 is designed as a valve 191. The valve 191 comprises multiple tongues or lugs 191′, 191″, 191″′, 191″″, which in the closed state of the valve 191 are domed inwardly in the direction of the reservoir 6. It is conceivable that a sealing foil 18″ (not illustrated) is provided above or below the valve 191, which sealing foil allows a particularly high-quality sealing action in the initial state. The sealing element 18 furthermore comprises a sealing body 19 having a pre-punched portion 18′. As an alternative to the sealing body 19 or to the pre-punched portion 18′, it is also conceivable that a sealing foil 18″ is present.

FIG. 7b shows a schematic perspective view of the sealing element 18 according to FIG. 7a in a preparation state of the cartridge system 1. The spike 73 has been led through the sealing body 19 in the region of the pre-punched portion 18′ and thus extends into the reservoir 6 of the cartridge 2. The spike 73 is thus situated in its deployed position. In the preparation state, the valve 191 is opened, for example by virtue of a positive pressure being generated in the reservoir 6 by means of a compressed-air line 40 of the spike 73, which positive pressure opens the valve 191. Beverage substance 7 can thus pass from the reservoir 6 through the valve 191 into the mixing chamber 8, and a beverage 70 can thus be prepared.

FIG. 7c shows a schematic perspective view of the sealing element 18 according to FIG. 7a in a reclosure state of the cartridge system 1. Here, the spike 73 remains in its deployed position. The valve 191 is closed and advantageously prevents beverage substance 7 from being able to pass through the valve 191 into the mixing chamber 8. In order to prepare a further beverage 70′, the cartridge system 1 can, after the reclosure state, be transferred into a further preparation state. Here, the valve 191 once again assumes its open position as per FIG. 7b.

### LIST OF REFERENCE DESIGNATIONS

1 Cartridge system
2 Cartridge
2′ Main body
2″ Cartridge wall
2″′ Cartridge base
2″″ Edge of the cartridge wall
6 Reservoir
7 Beverage substance
8 Mixing chamber
10 Cartridge receptacle
10′ Base structure
10″ Bottom side
10′″ Side wall of the base structure
11 Beverage outlet
12 Fluid feed
18 Sealing element
18′ Pre-punched portion of the sealing element
18″ Sealing foil
19 Sealing body
20 Connecting means
21 Counterpart connecting means
40 Compressed-air line
42 Compressed-air connection
43 Compressed-air outlet
71 Side channel
70 Beverage
73 Spike
80 Spike guide
90 Opening
190 Reclosable closure means
191 Valve
192 Reclosable region
191′ Lug
191″ Lug
191′″ Lug
191″″ Lug

1. A cartridge system for making a beverage, wherein the cartridge system is insertable into a beverage preparation machine, wherein the cartridge system comprises:
a) a cartridge, which comprises a reservoir filled with a beverage substance;
b) a cartridge receptacle, wherein the cartridge receptacle comprises:
a mixing chamber, which can be fluidically connected to the reservoir, and
a fluid feed, which opens into the mixing chamber; and
c) a sealing element, wherein the cartridge is reclosable by means of the sealing element.

2. The cartridge system as claimed in claim 1, wherein the cartridge is closed in an initial state of the cartridge system;
wherein the cartridge is open such that a fluidic connection between the reservoir and the mixing chamber is formed in a preparation state of the cartridge system; and
wherein the cartridge is closed in a reclosure state of the cartridge system after the preparation state.

3. The cartridge system as claimed in claim 2, wherein the cartridge is open such that a fluidic connection between the reservoir and the mixing chamber is formed in a further preparation state of the cartridge system after the reclosure state.

4. The cartridge system as claimed in claim 3, wherein the beverage substance that is present in the reservoir in the initial state of the cartridge system comprises at least one first portion and one second portion;
wherein the first portion of the beverage substance passes from the reservoir into the mixing chamber in the preparation state of the cartridge system;
wherein the second portion of the beverage substance passes from the reservoir into the mixing chamber in the further preparation state of the cartridge system.

5. The cartridge system as claimed in claim 2,
wherein the cartridge is closed at its side situated opposite a cartridge base by the sealing element in the initial state of the cartridge system; and
wherein the cartridge is closed at its side situated opposite the cartridge base by the sealing element in the reclosure state of the cartridge system.

6. (canceled)

7. The cartridge system as claimed in claim 1, wherein the sealing element comprises a reclosable region and/or a reclosable closure means.

8. (canceled)

9. The cartridge system as claimed in claim 7, wherein the reclosable closure means is designed such that the reclosable closure means opens and/or closes according to a pressure in the reservoir, such that the reclosable closure means is open above a threshold value of a pressure in the reservoir and is closed below the threshold value of the pressure in the reservoir.

10. The cartridge system as claimed in claim 7,
wherein the reclosable region and/or the reclosable closure means is closed in an initial state of the cartridge system,
wherein the reclosable region and/or the reclosable closure means is open such that the fluidic connection between the reservoir and the mixing chamber is formed by means of the reclosable region and/or the reclosable closure means in a preparation state of the cartridge system; and
wherein the reclosable region and/or the reclosable closure means is closed in a reclosure state of the cartridge system.

11. (canceled)

12. (canceled)

13. The cartridge system as claimed in claim 1, wherein the cartridge system has a movable spike, wherein the spike is movable between a retracted position, in which the spike is spaced from the sealing element, and a deployed position, in which the spike extends through the sealing element and projects into the reservoir.

14. (canceled)

15. The cartridge system as claimed in claim 13, wherein the spike is situated in the retracted position in an initial state of the cartridge system; and
wherein the spike is situated in the deployed position in a preparation state of the cartridge system.

16. (canceled)

17. (canceled)

18. A beverage preparation machine comprising the cartridge system as claimed in claim 1.

19. A method for producing the cartridge system as claimed in claim 1, wherein the cartridge is formed in a first method step, wherein the sealing element is fastened to the cartridge in a second method step.

20. The method as claimed in claim 19, wherein the cartridge is directly or indirectly connected to the cartridge receptacle in a third method step.

21. (canceled)

22. (canceled)

23. (canceled)

24. The method as claimed in claim 19, wherein the sealing element is crimped, adhesively bonded, sealed, and/or welded to a cartridge wall of the cartridge during the second method step.

25. A method for using a cartridge system as claimed in claim 1 for making a beverage.

26. The method as claimed in claim 25,
wherein the cartridge is closed in an initial state of the cartridge system;
wherein the cartridge is transferred into a preparation state of the cartridge system in a first use step, wherein the cartridge is open such that a fluidic connection between the reservoir and the mixing chamber is formed in the preparation state of the cartridge system,
wherein the beverage is prepared in the preparation state of the cartridge system;
wherein the cartridge is transferred into a reclosure state of the cartridge system in a second use step after the preparation state, wherein the cartridge is closed in the reclosure state of the cartridge system.

27. The method as claimed in claim 26, wherein the cartridge is transferred into a further preparation state of the cartridge system in a third use step after the reclosure state; wherein the cartridge is open such that a fluidic connection between the reservoir and the mixing chamber is formed in the further preparation state of the cartridge system; and wherein a further beverage is prepared in the further preparation state of the cartridge system.

28. The method as claimed in claim 26,
wherein the cartridge system has a movable spike;
wherein the spike is movable between a retracted position, in which the spike is spaced from the sealing element, and a deployed position, in which the spike extends through the sealing element and projects into the reservoir;
wherein the spike is situated in the retracted position in the initial state of the cartridge system, and
wherein the spike is moved into the deployed position in the first use step such that the spike is situated in the deployed position in the preparation state of the cartridge system.

29. The method as claimed in claim 28, wherein the spike is moved into the retracted position in the second use step such that the spike is situated in the retracted position in the reclosure state of the cartridge system, wherein the spike is moved into the deployed position in the third use step such that the spike is situated in the deployed position in the further preparation state of the cartridge system.

30. (canceled)

31. The method as claimed in claim 27, wherein the sealing element comprises a reclosable region and/or a reclosable closure means;
wherein the reclosable region and/or the reclosable closure means is closed in the initial state of the cartridge system;
wherein the reclosable region and/or the reclosable closure means is open in the first use step, wherein the reclosable region and/or the reclosable closure means is open such that the fluidic connection between the reservoir and the mixing chamber is formed by means of the reclosable region and/or the reclosable closure means in the preparation state of the cartridge system;
wherein the reclosable region and/or the reclosable closure means is closed in the second use step, wherein the reclosable region and/or the reclosable closure means is closed in the reclosure state of the cartridge system;
wherein the reclosable region and/or the reclosable closure means is open in the third use step, wherein the reclosable region and/or the reclosable closure means is open such that the fluidic connection between the reservoir and the mixing chamber is formed by means of the reclosable region and/or the reclosable closure means in the further preparation state of the cartridge system.
